(19) United States
(12) Patent Application Publication
(10) Pub. No.: US 2014/0077403 A1
(43) Pub. Date: Mar. 20, 2014

(54) PROCESS FOR MANUFACTURING COLOURED CERAMIC PARTS BY PIM

(71) Applicant: Commissariat A L'Energie Atomique Et Aux Energies Alternatives, Paris (FR)

(72) Inventors: Florence SERVANT, Vaulnaveys Le Haut (FR); Michel BAILLEUX, Saint Barthelemy De Sechilienne (FR)

(73) Assignee: Commissariat A L'Energie Atomique Et Aux Energies Alternatives, Paris (FR)

(21) Appl. No.: 14/085,986

(22) Filed: Nov. 21, 2013

Related U.S. Application Data
(63) Continuation of application No. PCT/FR2012/051300, filed on Jun. 11, 2012.

(30) Foreign Application Priority Data
Jun. 30, 2011 (FR) 11.55915

(51) Int. Cl. C04B 35/64

(52) U.S. Cl. CPC C04B 35/64
USPC 264/6

(57) ABSTRACT

A method of manufacturing a master batch for the molding of colored parts, including the steps of: preparing a mixture comprising an inorganic powder, advantageously ceramic, and a dye; submitting the mixture to a spray-drying step to obtain an atomized powder; submitting said atomized powder to a presintering step; mixing the presintered powder with an organic binder, advantageously polymeric, to obtain the master batch.

### TECHNICAL FIELD

The present invention relates to the forming of colored parts by PIM injection (Power Injection Molding), and more specifically to the preparation of master batches (feedstocks) used for injection or extrusion molding.

More specifically, the present invention relates to a new method for forming a master batch using a pre-treatment of the colored powder before mixing with the organic binder.

### BACKGROUND

The PIM injection molding technique (or microPlM in the case of ultra-fine powders) is currently used to form various objects. Powder injection molding is a method in several steps which combines plastic injection molding and the consolidation used in powder metallurgy by any type of sintering. It enables to form metal and ceramic components.

In such a method, the first step comprises obtaining a master batch (or feedstock) adapted to the targeted application. The master batches are made of a mixture of organic material (or polymer binding agent) and of inorganic powders (metal or ceramic).

Then, the master batch can be injected like a thermoplastic. Finally, the part is debound and then sintered.

More specifically, feedstocks made of polymer materials used as a binding agent and of metal or ceramic powders, are produced at high temperature and injected into a mold. This results in an injected part made of powder-filled polymer, called “green” part. Such a green part has the same shape as the final part, but is larger.

The polymers which have been used to allow the injection of material then have to be extracted by debinding. The binding agent is thus extracted, after which the resulting part, then called “brown”, is sintered to be hardened and densified while homothetically keeping the shape of the “green” part. This results in ceramic and metal parts.

In known fashion, there exist various debinding techniques according to the chemical and/or physical composition of the polymers used: catalytic debinding, thermal debinding, solvent, water, or supercritical CO₂ debinding.

One of the main elements to successfully obtain a crack-free part having the desired shape and details is the chemical composition of the binding agent used in the feedstock. The mixture should be sufficiently fluid to be injected and molded, and have a good mechanical resistance enabling to demold and to handle the green part. Further, it should comprise no organic or inorganic matter capable of degassing during the feedstock manufacturing process, since this could result in the presence of pores in the final part.

It is also important to mix a maximum amount of powder with the binder, that is, to have a high powder filling ratio to minimize the shrinkage of the part during the sintering and thus avoid cracks in the parts, while improving the density of the parts. Critical (maximum) filling ratios, varying according to the size of the powder and to its chemical and/or physical properties, are generally in the range between 40 and 75% by volume.

Further, the nanometric ceramic powders used are generally conditioned after a spray-drying or atomization-drying step [Masters, K. Spray Drying, Handbook, 1991, p. 569 ff].

The powder then appears in the form of regular spherical agglomerates. The spray drying technique comprises injecting a liquid solution through a nozzle which vibrates at a given frequency to form drops which will then be dried in situ. The solution used is implemented based on powder mixed with a liquid, which may have different natures: water, a solvent such as ethanol, or also a polymeric binder, dissolved or not (for example, PVA). This solution is more or less filled with powder according to the filling ratio desired for the spheres. The spheres are however very porous in the end, given that the liquid has dried partially (case of polymeric binders) or totally (case of water, alcohol . . . ). Despite this porosity imposed by the technique, spray drying enables to obtain powders which have a higher apparent density, as compared with agglomerates in the form of balls forming a highly-expanded network. Thus, and as an example, the gain is approximately 30% for a zirconia powder at 6.8 mm²/g.

This technique is currently used in powder metallurgy for several reasons:

First, the powder resulting from the spray drying, said to be atomized, has the advantage of being more easy to handle in a more secure fashion, the powder being less volatile.

Further, its castability is advantageous. The notion of castability may be defined by several methods, from the most empirical to more scientific and quantitative methods. The methods closest to powder usage methods are generally implemented, in particular a flowing through an orifice. It is for example possible to measure the time taken by 50 g of powder to flow through a funnel having a diameter in the range from 2 to 5 mm Experimental parameters vary according to the nature of the powder since they largely depend on the intensity and the nature of interaction forces between particles. This is a comparative experiment between non-atomized and atomized powders. A non-atomized highly pulverulent powder may take an infinite time to flow, while a properly-atomized powder may flow very fast. The presence of polymeric binders also enables to improve the fluidity of the powder.

Such a fluidity enables to increase the packed powder density. The spheres arrangement in a volume V is better than that of the powder in the form of random agglomerates (or in the form of expanded balls). Thus, in conventional pressing methods (isostatic, uniaxial, cold or hot pressing), the raw density of the parts is improved. Such a better arrangement of spherical agglomerates in the case of an atomized powder thus enables to considerably improve the density of the sintered parts (by natural sintering, by SPS (“Spark Plasma Sintering”), by HIP (“Hot Isostatic Pressing”).

In the case of a molding by injection of ceramic powder (CIM), the use of atomized powder is only advantageous in terms of safety. It is besides widely used in the powder molding of zirconia, since sintered ceramic parts are formed with nanometric powder have a high specific surface (for example, 6.9 g.cm² for 3YSE zirconia (Tosoh Corporation). In this case, the advantages of atomization due to a better packed density are now pointless since the powder is mixed at a high temperature with polymeric binders to form the feedstock. Here, the powder is injected instead of being packed. The shear stress applied by the mixer or the extruder causes a separation of the atomized spheres. The powder behaves as if it had not been atomized, as illustrated in FIG. 1. The electrostatic forces which used to maintain the powder crystallites in the form of spherical agglomerates have a much lower intensity than the shear stress applied during the mixing. The use of polymeric binders during the atomization could prevent such a dispersion, but these are taken to a temperature higher than their melting temperature to form a very homogeneous mixture of powder and polymer. Indeed, such a homogeneity of the mixture is crucial to form crack-less parts after the molding, the debinding, and the sintering (a homogeneous shrinkage is required).

In one specific case, the ceramic powders are colored. Methods for coloring ceramic powders are known. The pigments added for the coloring are metal oxides or metal precursors. They may be mixed to the initial solution before spray-drying. The pigments are intimately mixed with the ceramic, after spray-drying, and can be found between grains. Once the ceramic has been sintered, the pigments are inserted at the grain boundaries in the form of metal oxides, in the form of precipitates in the ceramic matrix (new phase between the metal oxide and the ceramic), or in dissolved form (solid solution in the ceramic).

The use of atomized colored ceramic powder in the manufacturing of master batches may however raise implementation issues. Indeed, the master batches may have rheological behaviors different from those of the non-colored powder.

Indeed, the master batch using colored ceramics, especially based on precursors, degasses during the forming of the mixture at high temperature. It thus has a foamy aspect. The master batch is then provided with a large number of pores during its cooling. The master batches cannot be injected afterwards, which is a nuisance in the CIM process.

There thus is an obvious need to develop new technical solutions enabling to avoid the above-mentioned drawbacks, especially in relation with colored ceramics and CIM technology.

### SUMMARY OF THE INVENTION

The present invention relates to the manufacturing by molding of colored ceramic parts. It provides submitting the atomized colored powder to a presintering or anneal step before preparation of the feedstock.

More specifically, the present invention relates to a method for manufacturing a master batch intended for the molding of colored parts, which comprises the steps of:
preparing a mixture comprising an inorganic powder, advantageously ceramic, and a dye;
submitting the mixture to a spray-drying step to obtain an atomized colored powder;
submitting said atomized colored powder to a presintering step;
mixing the presintered colored powder to an organic binder, advantageously polymeric, to obtain the master batch.

The mixture used according to the invention thus comprises at least one inorganic powder, or even a mixture of inorganic powders. The present invention is particularly capable of manufacturing ceramic parts, thus formed based on ceramic powder(s) such as zirconium oxide (or zirconia), possibly doped or stabilized by means of yttrium, magnesium, cerium, or calcium, typically by from 2 to 20% by mass, advantageously from 2 to 8%.

The mixture further contains at least one dye, or even a mixture of dyes, advantageously amounting to from 0.1 to 15% by mass of the powder. The dye advantageously is a colored pigment. It may be a metal oxide, such as iron oxide, inserted as such into the powder, or inserted in ion form as a metal precursor.

Advantageously, the inorganic powder especially containing the dye is submicronic with crystallites, that is, elementary particles in the form of dispersed grains, having an average size smaller than or equal to approximately 5 micrometers, advantageously smaller than 30 nanometers.

Since the mixture is intended to be submitted to a spray-drying step, it advantageously contains a liquid in order to form a solution. Advantageously, the liquid is water, the mixture appearing in the form of an aqueous solution.

The next step comprises submitting the mixture to a spray-drying step in conventional conditions, known by those skilled in the art.

Optionally, a sieving intended to eliminate spherical agglomerates having a size greater than a given size, typically a few tens of micrometers, for example, 200 or 50 micrometers, may then be performed.

Typically, according to the invention, the powder thus atomized (which is also colored and possibly sieved) is then submitted to an anneal or presintering step.

The presintering temperature may be previously determined by a dilatometry measurement on a pellet of powder, advantageously of colored ceramic, obtained by pressing.

The curve of thermal expansion versus temperature reaches a maximum point just before the sintering, which enables the material to decrease its volume (in the case of a densifying sintering). The shrinkage of the material is in the order of from 10 to 30% according to the pressure exerted on pressing and to the type of powder (especially colored ceramic) used.

Generally, the presintering temperature is temperature T1 corresponding to the maximum thermal expansion, just before the sintering.

The lower limit of temperature T1 is 0.8×T1, preferably 0.9×T1.

The upper limit of temperature T1 is temperature T2 corresponding to a 2% shrinkage due to the sintering, preferably 1%.

In the specific case of brown yttria-stabilized zirconia (containing 3% by mass of iron oxide), the presintering temperature is preferably in the range between 640° C. and 1,030° C., more preferably still between 720° C. and 1,000° C. More generally, the presintering is carried out at a temperature in the range between 500° C. and 1.400° C., preferably between 700° C. and 1,200° C. for zirconia.

The presintering should thus performed at a sufficiently low temperature to avoid any volume increase of the grains, which would make the powder, advantageously, a ceramic, lose its good sintering properties (due to the small size of its crystallites). It should be noted that the grain growth can be controlled by FEG SEM (field emission gun scanning electron microscope) and the crystal phases can be controlled by X diffraction.

Further, the presintering should be performed at a sufficiently high temperature for the spherical agglomerates to be strong enough to resist the shear stress of the mixer or of the extruder used to form the master batch. This can be checked after debinding of the polymer. The debound powder can be observed with an optical microscope or with a scanning electron microscope according to the size of the atomized spheres. If the powder has kept the same spherical shape as the atomized presintered powder before the mixing, this means that the temperature was sufficiently high. The debound powder can also be compared with the atomized presintered powder before mixing by previously-defined fluidity measurements.

In practice, the step of presintering or annealing the atomized powder is advantageously carried out for from 1 to 10 hours, preferably for from 2 to 6 hours.

This, this anneal treatment of the atomized powder enables to keep the advantages of its conditioning in spherical agglomerates adapted to the CIM process. The atomized powder is totally or partly presintered (advantageously at least 10% by mass).

One of the advantages of such a presintering step is to totally discharge the gases produced by the precursors and additives used during the liquid preparation for the atomizing. Thus, the master batch no longer has a foamy aspect and can be injected afterwards without trapping pores in the polymer, which is incompatible with the manufacturing of dense parts.

Further, the maintained fluidity of the powder enables it to have a fine rheological flow in the molten polymer, the master batch having a lower viscosity for an identical filling ratio, which enables to increase the filling ratio for a given polymer composition. This also eases the injection operation from a rheological point of view. A higher filling ratio enables to have less shrinkage on sintering, and thus less cracks associated with the shrinkage.

Another advantage is that the homogeneity of the mixture is improved by this process. Indeed, the gas discharge during the debinding is eased by the presence of preferred channels. Such channels result from the more regular stacking of the spherical ceramic agglomerates.

The next step corresponds to the actual preparation of the master batch. Conventionally, this comprises mixing the colored powder thus pre-treated (atomized and presintered) with an organic binder, advantageously polymeric, intended to be eliminated during the debinding step.

Typically, the powder resulting from the previous steps (colored, atomized, and presintered) amounts to from 40 to 75% by volume of the master batch, preferably between 50 and 65%.

Advantageously, the organic binder, advantageously polymeric, comprises one or several addition polymers behaving as a plasticizer, lubricant, and/or surfactant. In practice, and preferably, it comprises:
a stable homo- or copolymer having a good ductility, such as LLDPE (linear low-density polyethylene);
a lubricant, such as paraffin wax (for example, polyethylene wax, PW); and
a plasticizer, such as polyethylene glycol (PEG), in appropriate mass proportions.

A surfactant or a dispersant such as stearic acid (SA) may be added to such a ternary mixture.

The master batch is then formed by extrusion by means of an extruder or by means of a kneader-type mixer, at high temperature so as to melt the polymers. According to another aspect, the invention also aims at a method for manufacturing colored molded parts which comprises the steps of:
preparing a master batch according to the method forming the object of the invention;
injecting the master batch into a mold to form the part;
debinding the part;
sintering the part.

The master batch is advantageously prepared as described hereabove.

According to a preferred embodiment, the feedstock thus prepared is cooled and granulated, advantageously by means of a granulator. It is then used as a raw material for the injection, where it will be remelted.

The injection into an adapted mould is performed conventionally, advantageously under pressure. Typically, the granules are heated in the injection screw and then injected into a matrix.

Conventionally, the debinding step is intended to remove the polymeric binder. It advantageously is a chemical debinding or a thermal debinding.

The thermal debinding temperatures are advantageously in the range between 0 and 600° C., and the temperature ramps are very slow to avoid the occurrence of cracks (between 5 and 150° C./hour, preferably between 5 and 20° C./hour). The debinding of ceramics is advantageously performed under air.

The next step is sintering. The sintering temperature depends on the granulometry of the powder, on its nature, and on the nature of the coloring oxides. Advantageously, the sintering is performed at a temperature in the range between 1,250° C. and 1,400° C. The sintering generally lasts for between 1 hour and 10 hours, advantageously for 5 hours.

The advantages of the present invention will better appear from the following embodiments.

### DESCRIPTION OF THE DRAWINGS

FIG. 1 corresponds to a scanning electron microscopy (SEM) view of a debound powder (3% yttria-stabilized zirconia+3% of iron oxide), which has not been presintered after spray-drying.

FIG. 2 corresponds to an SEM view of a debound powder (3% yttria-stabilized zirconia+3% of iron oxide), which has been presintered after spray-drying.

FIG. 3 shows a curve of thermal expansion of the 3% yttria-stabilized zirconia, containing 3% of iron oxide.

### EXAMPLES OF EMBODIMENT

The following non-limiting embodiments, in relation with the accompanying drawings, aim at illustrating the invention.

To illustrate the advantages of the method according to the invention, four feedstocks containing 53% of 3% yttria-stabilized zirconia powder (TZ3YS-E, Tosoh Corporation), colored by means of 3% by mass of iron oxide, mixed via spray-drying, have been prepared:
the first feedstock (1) has been prepared from a powder which has been submitted to no presintering;
the second feedstock (2) has been prepared from a powder which has been submitted to a presintering at 600° C.;
the third feedstock (3) has been prepared from a powder which has been submitted to a presintering at 900° C.;
the fourth feedstock (4) has been prepared from a powder which has been submitted to a presintering at 1,100° C.

The experiments have been performed with a temperature rise and fall rate of 100° C./hour, and a temperature stage of 5 hours.
1/Description of the atomized powders:

The spray-drying has been performed with an ultrasound nozzle at a 33-Hz frequency at 240° C. with a 500-mL/hflow rate.

A sieving with a 100-micrometer sieve has been performed before the presintering.

The atomized spheres have a median diameter (d50) of approximately 59 μm, before and after the presintering.

The packed densities of the atomized powder, before and after the presintering, are equivalent and equal to 1.5 g/cm³.

The atomized powder which has not been presintered (1) has not flowed through a nozzle trumpet having a 5-mm diameter. On the contrary, once presintered at 600° C., 900° C., or 1,100° C., the atomized powders, (2), (3), and (4) have improved their flow since they have taken 29, 28, and 26 seconds to flow, respectively.
2/ Feedstock Preparation:

To prepare the feedstocks, the atomized powders, possibly presintered, are mixed in a mixer or in an extruder with a mixture of three polymers by the following proportions:
LLDPE up to 53% by mass;
PEG 20,000 up to 29% by mass;
paraffin wax, more specifically polyethylene wax (PW) up to 18% by mass; that is, 100% by mass.

Stearic acid (SA) is added up to 7.8% by mass of the total of the ternary mixture (LLDPE+PEG+PW).

The mixture is here filled with powder at 53% by volume (with respect to the four polymers: SA+LLDPE+PEG+PW)

3/ Description of the Feedstocks:

The master batch of the atomized powder which has not been presintered (1) is foam and impossible to inject.

The master batch of the atomized powder presintered at 600° C. (2) is less foamy but cannot be well injected: the test tubes are only half filled. The master batch of the atomized powder presintered at 900° C. (3) is non foamy, easy to extrude and to inject. The parts are sintered between 96 and 99.5% with no cracking.

The master batch of the atomized powder presintered at 1,100° C. (4) is non-foamy, abrasive for machines, and has a good injection ability. However, the sintered parts are very porous: 77% of the theoretical density.

4/ Debinding of the Injected Parts:

The feedstocks, (2), (3), and (4) are then injected into a Battenfeld press to form the parts, according to the following conditions:
hopper temperature: 150° C.,
nozzle temperature: 170° C.,
pressure: 140 bars.

The debinding of the injected parts is carried out thermally under air, by thermo-oxidation at 12° C./hour up to 300° C. with a 3-hour stage at this temperature, and then at 12° C./hour up to 400° C., with a 3-hour stage at this temperature.

5/ Observation of the Debound Parts:

The debound parts, which have no mechanical resistance, are very easy to be reduced to powder form and have been observed with a scanning electron microscope (SEM).

A piece of the feedstock (1), which has been submitted to no presintering and is impossible to inject, has been debound with the same cycle, to observe the powder.

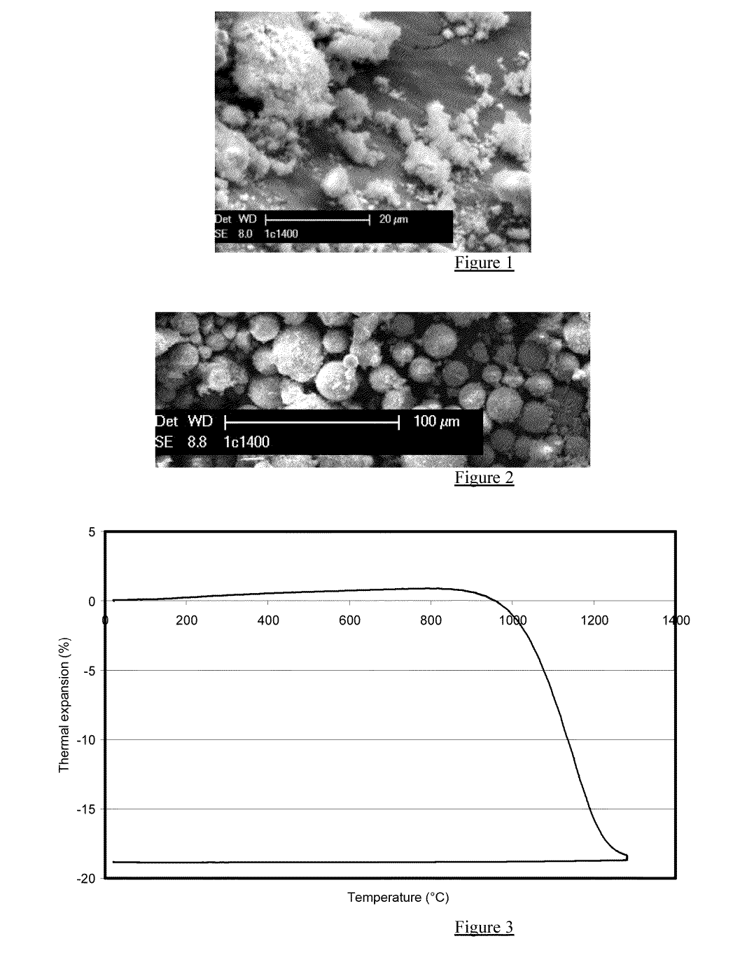

The debound powders originating from feedstocks (1) and (2) (no anneal and anneal at 600° C., respectively) are formed of ball-shaped agglomerates (FIG. 1). This shows that the spherical agglomerates have separated during the mixing and that the nanometric powder has recovered its natural shape.

The debound powders originating from feedstocks (3) and (4) (annealed at 900° C. and 1,100° C., respectively) are always agglomerated in spherical form (FIG. 2). These powders flow in less than 30 seconds.

6/Sintering of the Debound Parts:

The injected green parts originating from feedstocks (2), (3), and (4) have then been sintered at a 1,300° C. temperature for 5 hours.

This results in a density of 99.1% for the half-part (2) resulting from a powder presintered at 600° C., a 98.7% density for the whole crackless part (3), and 77% for the porous part resulting from powder (4).

These experiments show that colored zirconia can only be injected on the condition that the powder is submitted to a presintering (or anneal) after spray-drying. The quality of the final part further depends on the presintering temperature.

7/ Determination of the Optimal Presintering Temperature:

Experimentally, a comparison of feedstocks (2), (3), and (4) shows that the optimal presintering temperature is greater than 600° C. in the case of the powder of 3% yttria-stabilized zirconia (TZ3YS-E, Tosoh Corporation), colored by means of 3% by mass of iron oxide.

Indeed, the presintering temperature may be previously determined by a dilatometry measurement on a pellet of colored ceramic formed by pressing.

Theoretically, the curve of thermal expansion versus temperature reaches a maximum just before the sintering, which enables the material to decrease its volume (in the case of a densifying sintering). The shrinkage of the material is in the range from 10 to 30% according to the pressure exerted during the pressing and to the type of colored ceramic used.

FIG. 3 illustrates a curve of thermal expansion according to temperature for zirconia colored in brown by iron oxide pressed at 50% of the theoretical density. The temperature where the obtained expansion is maximum is 800° C., the sintering temperature is 1,150° C. (temperature where the sintering speed is maximum) and the sintering ends at 1,350° C.

The presintering temperature thus is temperature T1 corresponding to the maximum thermal expansion, just before the sintering. It is here equal to 800° C.

The lower limit of temperature T1 is 0.8×T1, preferably 0.9×T1, 640° C., or even 720° C.

The upper limit of this temperature is temperature T2 corresponding to a 2% shrinkage due to the sintering, preferably a 1% shrinkage due to the sintering, that is, 1,030° C., or even 1,000° C.

Thus, for brown yttria-stabilized zirconia, the presintering temperature may range between 640° C. and 1,030° C., preferably between 720° C. and 1,000° C. Indeed, the experiment at 1,100° C. reveals an unsatisfactory grain growth and porosity.

1. A method of manufacturing a master batch for the molding of colored parts, comprising the steps of:
preparing a mixture comprising an inorganic powder and a dye;
submitting the mixture to a spray-drying step to obtain an atomized powder;
submitting said atomized powder to a presintering step;
mixing the presintered powder with an organic binder to obtain the master batch.

2. The method of manufacturing a master batch of claim 1, wherein the inorganic powder is ceramic.

3. The method of manufacturing a master batch of claim 1, wherein the organic binder is polymeric.

4. The method of manufacturing a master batch of claim 2, wherein the ceramic powder is zirconia.

5. The method of manufacturing a master batch of claim 4, wherein zirconia is doped.

6. The method of manufacturing a master batch of claim 5, wherein the zirconia is doped with yttrium.

7. The method of manufacturing a master batch of claim 1, wherein the dye is a colored pigment.

8. The method of manufacturing a master batch of claim 7, wherein the colored pigment is a metal oxide.

9. The method of manufacturing a master batch of claim 8, wherein the metal oxide is iron oxide, or a metal precursor.

10. The method of manufacturing a master batch of claim 1, wherein the dye amounts to from 0.1 to 15% by mass of the inorganic powder.

11. The method of manufacturing a master batch of claim 1, wherein the mixture submitted to the spray-drying step is an aqueous solution.

12. The method of manufacturing a master batch of claim 4, wherein the presintering step occurs at a temperature in the range between 500° C. and 1,400° C., advantageously between 700° C. and 1,200° C.

13. The method of manufacturing a master batch of claim 1, wherein the presintering step occurs for a duration in the range between 1 and 10 hours, preferably between 2 and 6 hours.

14. The method of manufacturing a master batch of claim 1, wherein the organic binder comprises a stable polymer having a good ductility, a lubricant, a plasticizer.

15. The method of manufacturing a master batch of claim 14, wherein the organic binder comprises a surfactant.

16. The method of manufacturing a master batch of claim 1, wherein the presintered powder amounts to from 40 to 75% by volume of the master batch, preferably between 50 and 65%.

17. A method of manufacturing a colored molded part comprising the steps of:
preparing the master batch according to the method of claim 1;
injecting the master batch into a mold to form the part;
debinding the part;
sintering the part.

18. The method of manufacturing parts of claim 17, wherein the sintering is performed at a temperature ranging between 1,250° C. and 1,400° C.
